(19) United States
(12) Patent Application Publication
(10) Pub. No.: US 2026/0217371 A1
(43) Pub. Date: Jul. 30, 2026

(54) SOFT-OPENING TRAY TABLE FOR VEHICLE PASSENGER SEATS

(71) Applicant: SAFRAN SEATS USA LLC, Gainesville, TX (US)

(72) Inventor: Juan Francisco Lopez Chavira, Gainesville, TX (US)

(73) Assignee: SAFRAN SEATS USA LLC, Gainesville, TX (US)

(21) Appl. No.: 19/149,230

(22) PCT Filed: Mar. 1, 2023
(86) PCT No.: PCT/US2023/014249

§ 371 Date: Jul. 18, 2025

(51) Int. Cl. B64D 11/06; B60N 3/00

(52) U.S. Cl. CPC B64D 11/0638; B60N 3/004

(57) ABSTRACT

A soft-opening tray table assembly for a passenger seat for a vehicle such as aircraft is provided. The soft-opening tray table assembly can include a first arm; a second arm; and a tray table positioned between the first arm and the second arm, the tray table being pivotably coupled to the first arm by a first hinge and the second arm by a second hinge. The first hinge can counteract a gravitational force acting on the tray table during rotation from a stowed position to a deployed position. The first hinge can impart at least one of a friction force, a spring force, and a viscous damping force. In some examples, the hinge can include a hinge housing having an annular cavity axially aligned with a rotation axis of the tray table; an axial plunger slidable within the annular cavity; and a damper assembly positioned adjacent to the axial plunger.

### FIELD OF DISCLOSURE

The present disclosure relates to tray table assemblies. More particularly, the present disclosure relates to tray table assemblies associated with vehicle passenger seats and having features for soft-opening and/or extension.

### BACKGROUND

Passenger vehicles, such as aircraft, buses, trains, ships, and automobiles, often include one or more passenger seats in which passengers are seated during travel. A passenger seat often utilizes arm rests, foot rests, tray tables, back rests, displays, leg rests, portable electronic device (PED) supports, or other similar types of translating or pivoting (e.g., moving) components. For example, arm rests, tray tables and portable electronic device (PED) supports are typically mounted to passenger seats in an articulated (e.g., pivotal) manner. In use, these components may be rotated between stowed and deployed positions.

The articulating components can be affected by gravity during rotation between stowed and deployed positions. For example, conventional tray tables generally include low friction hinges which cause the tray table to rotate from the stowed position to the deployed position based primarily on gravity once a latch, stop, or other stowing feature is disengaged. Such gravitational deployment can cause sudden impact with the stop features (e.g., stopping the tray table when it reaches a horizontal position), resulting in excess noise, bouncing/shaking components, vibrations through the seat to other passengers, premature part failure, and non-premium feel, among other disadvantages.

### SUMMARY

The present disclosure provides examples of a soft-opening tray table assembly including components and/or features configured to at least partially counteract the gravitational force acting upon the tray table as it rotates from a stowed position to a deployed position and to an extended position. For example, after the tray table assembly is unlatched by a passenger and deployment begins, at least a portion of the rotation of the tray table from gravitational force can be restrained by including a component providing a counteracting rotational force on the tray table. Embodiments of the present disclosure can include counteracting rotational force from a frictional force, a potential energy storage, and/or viscous damping, among others to limit the opening angular velocity of the tray table.

In accordance with an aspect of the present disclosure, a soft-opening tray table for a passenger seat is provided. In an embodiment, the soft-opening tray table assembly comprises a first arm configured to operably couple to a first portion of a passenger seat; a second arm configured to operably couple to a second portion of the passenger seat; and a tray table positioned between the first arm and the second arm, the tray table being pivotably coupled to the first arm by a first hinge and pivotably coupled to the second arm by a second hinge. The first hinge can counteract a gravitational force acting on the tray table during rotation from a stowed position to a deployed position.

In accordance with another aspect of the present disclosure, a soft-opening tray table assembly for an aircraft passenger seat is provided. In an embodiment, the soft-opening tray table assembly includes a bracket configured to operably couple to the aircraft passenger seat; a tray table pivotably coupled to the bracket by a hinge, the hinge comprising: a hinge housing having an annular cavity axially aligned with a rotation axis of the tray table; an axial plunger slidable within the annular cavity; and a damper assembly positioned adjacent to the axial plunger; and a threaded member operably coupled to the bracket and extending within the annular cavity to interface with the axial plunger. Rotation of the axial plunger with respect to the threaded member during rotation of the tray table from a stowed position to a deployed position can cause axial translation of the axial plunger within the annular cavity toward the damper assembly, and the axial plunger can abut the damper assembly to viscously dampen at least a portion of the axial translation of the axial plunger.

In any of the embodiments of the present disclosure, the first hinge can counteract the gravitational force with at least one of a friction force, a spring force, and a viscous damping force.

In any of the embodiments of the present disclosure, the second hinge can counteract the gravitational force acting on the tray table during rotation from the stowed position to the deployed position.

In any of the embodiments of the present disclosure, the first hinge can counteract the gravitational force with a friction force, and wherein the second hinge can counteract the gravitational force with at least one of a friction force, a spring force, and a viscous damping force.

In any of the embodiments of the present disclosure, the first hinge can counteract the gravitational force with a spring force, and wherein the second hinge can counteract the gravitational force with at least one of a friction force, a spring force, and a viscous damping force.

In any of the embodiments of the present disclosure, the first hinge can counteract the gravitational force with a viscous damping force, and wherein the second hinge can counteract the gravitational force with at least one of a friction force, a spring force, and a viscous damping force.

In any of the embodiments of the present disclosure, the first and second arms can be pivotably coupled to the passenger seat, and wherein the first and second arms are configured to rotate the tray table from the stowed position to an extended position.

In any of the embodiments of the present disclosure, the soft-opening tray table can further comprise a linear damper assembly positioned between the aircraft passenger seat and the first arm, wherein the linear damper assembly can be configured to dampen the movement of the tray table during rotation from the stowed position to the extended position.

In any of the embodiments of the present disclosure, the linear damper assembly is a first linear damper assembly, and wherein the soft-opening tray table assembly further comprises a second linear damper assembly positioned between the aircraft passenger seat and the second arm, wherein the second linear damper assembly can be configured to dampen the movement of the tray table during rotation from the stowed position to the extended position.

In any of the embodiments of the present disclosure, an aircraft passenger seat can comprise the soft-opening tray table.

In any of the embodiments of the present disclosure, the bracket is a first bracket, the hinge is a first hinge, and the threaded member is a first threaded member, and wherein the tray table assembly further comprises: a second bracket configured to operably couple to the aircraft passenger seat away from the first bracket, wherein the tray table is pivotably coupled to the second bracket by a second hinge positioned on an opposite end of the tray table from the first hinge, and wherein the second hinge comprises: a second hinge housing having a second annular cavity axially aligned with the rotation axis of the tray table; a second axial plunger slidable within the second annular cavity; and a second damper assembly positioned adjacent to the second axial plunger; a second threaded member operably coupled to the second bracket and extending within the second annular cavity to interface with the second axial plunger, wherein rotation of the second axial plunger with respect to the second threaded member during rotation of the tray table from the stowed position to the deployed position causes axial translation of the second axial plunger within the second annular cavity toward the second damper assembly, and wherein the second axial plunger can abut the second damper assembly to viscously dampen at least a portion of the axial translation of the second axial plunger.

In any of the embodiments of the present disclosure, the viscous damping of the axial translation of the axial plunger can counteract a gravitational force acting on the tray table during rotation from the stowed position to the deployed position.

In any of the embodiments of the present disclosure, the viscous damping of the axial translation of the first and second axial plungers can counteract a gravitational force acting on the tray table during rotation from the stowed position to the deployed position.

In any of the embodiments of the present disclosure, the bracket can be pivotably coupled to the aircraft passenger seat, and wherein the bracket is configured to rotate the tray table from the stowed position to an extended position.

In any of the embodiments of the present disclosure, the tray table can further comprise a linear damper assembly positioned between the aircraft passenger seat and the bracket, wherein the linear damper assembly can be configured to dampen the movement of the tray table during rotation from the stowed position to the extended position.

In any of the embodiments of the present disclosure, the first and second brackets can be pivotably coupled to the aircraft passenger seat, and wherein the first and second brackets can be configured to rotate the tray table from the stowed position to an extended position.

In any of the embodiments of the present disclosure, the tray table can further comprise a linear damper assembly positioned between the aircraft passenger seat and the first bracket, wherein the linear damper assembly can be configured to dampen the movement of the tray table during rotation from the stowed position to the extended position.

In any of the embodiments of the present disclosure, the linear damper assembly is a first linear damper assembly, and wherein the soft-opening tray table assembly further comprises a second linear damper assembly positioned between the aircraft passenger seat and the second bracket, wherein the second linear damper assembly can be configured to dampen the movement of the tray table during rotation from the stowed position to the extended position.

This summary is provided to introduce a selection of concepts in a simplified form that are further described below in the Detailed Description. This summary is not intended to identify key features of the claimed subject matter, nor is it intended to be used as an aid in determining the scope of the claimed subject matter.

### DESCRIPTION OF THE DRAWINGS

The foregoing aspects and many of the attendant advantages of the claimed subject matter will become more readily appreciated as the same become better understood by reference to the following detailed description, when taken in conjunction with the accompanying drawings, wherein:

FIG. 1 depicts one example of an environment, such as a passenger seat assembly shown in perspective view, in which technologies and/or methodologies of the present disclosure may be employed;

FIG. 2A is a cross-sectional side view of one embodiment of a soft-opening tray table assembly formed in accordance with aspects of the present disclosure; and

FIGS. 2B and 2C are cross-sectional top and side detail views, respectively, of the soft-opening tray table assembly of FIG. 2A.

### DETAILED DESCRIPTION

The detailed description set forth above in connection with the appended drawings, where like numerals reference like elements, are intended as a description of various embodiments of the present disclosure and are not intended to represent the only embodiments. Each embodiment described in this disclosure is provided merely as an example or illustration and should not be construed as preferred or advantageous over other embodiments. The illustrative examples provided herein are not intended to be exhaustive or to limit the disclosure to the precise forms disclosed.

As will be described in more detail below, the present disclosure provides examples of soft-opening tray table assemblies for aircraft passenger seats. As used herein, “soft-opening” refers to motion of the tray table during rotation from a stowed position to a deployed position, where the motion is slower than motion of the tray table rotating by gravitational force alone, without any counteracting rotational force. The soft-opening can result from a force on the tray table to counteract the gravitational force. The counteracting force can be exerted on the tray table through the hinges coupling the tray table to the aircraft seat, e.g., a friction force, a spring force (e.g., transferring kinetic energy to potential energy), a damping force (e.g., viscous damping), and combinations thereof.

In embodiments described herein, the soft-opening tray table assemblies include components and/or features configured to at least partially counteract the gravitational force acting upon the tray table as it rotates from a stowed position to a deployed position and to an extended position. For example, after the tray table assembly is unlatched by a passenger and deployment begins, at least a portion of the rotation of the tray table from gravitational force can be restrained by including a component providing a counteracting rotational force on the tray table. Embodiments of the present disclosure can include counteracting rotational force from a frictional force, a potential energy storage, and/or viscous damping, among others to limit the opening angular velocity of the tray table. Configurations of the aircraft passenger seat having soft-opening tray tables can reduce noise, extend component life, reduce vibration felt by other passengers, and provide improved aesthetic feel, among other advantages.

Although embodiments of the present disclosure may be described with reference to tray table assemblies for an aircraft passenger seat, one skilled in the relevant art will appreciate that the disclosed embodiments are illustrative in nature and therefore should not be construed as limited to such an application. It should therefore be apparent that the disclosed technologies and methodologies have wide application, and therefore may be suitable for use with many types of tray table arrangements, including trays of any type, such as those in passenger seats employed in buses, trains, ships, and the like. Accordingly, the following descriptions and illustrations herein should not limit the scope of the claimed subject matter.

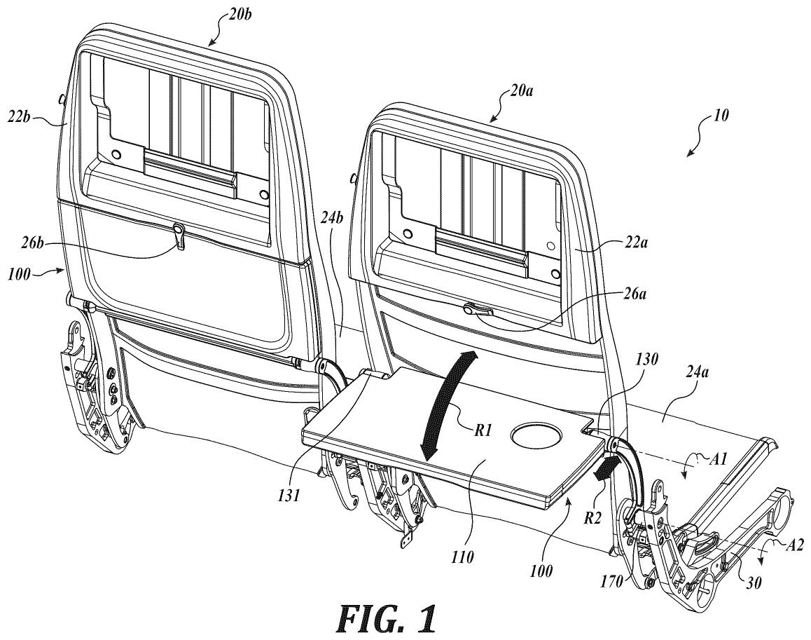

FIG. 1 depicts one example of an environment, such as a passenger seat assembly 10 shown in perspective view, in which technologies and/or methodologies of the present disclosure may be employed. The passenger seat assembly 10 can include one or more seat assemblies 20a and 20b operably coupled to a seat base frame assembly 30. Although the passenger seat assembly 10 is shown in a configuration for carrying two passengers and accordingly includes two seat backs 22a and 20b and two seat bases 24a and 24b, the passenger seat assembly 10 suitable for use with embodiments of the present disclosure can be configured to carry one passenger, or more than two passengers with corresponding quantity of seat assemblies 20a and 20b. The seat backs 22a and 22b can be pivotable relative to their respective seat bases 24a and 24b and the seat base frame assembly 30 such that the seat backs 22a and 22b can be rotated to various positions such as an upright taxi-takeoff-landing (TTL) position, a reclined position, etc.

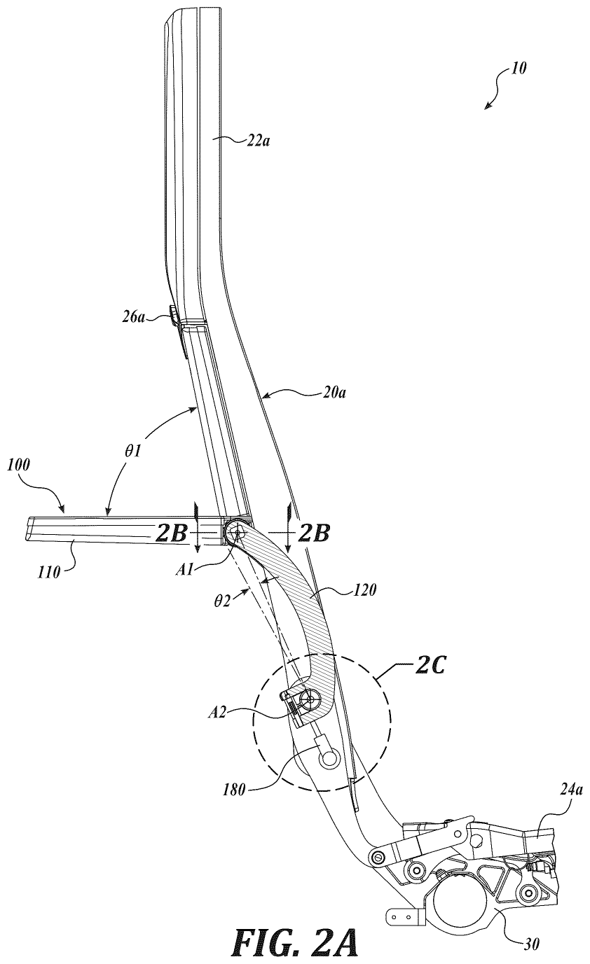

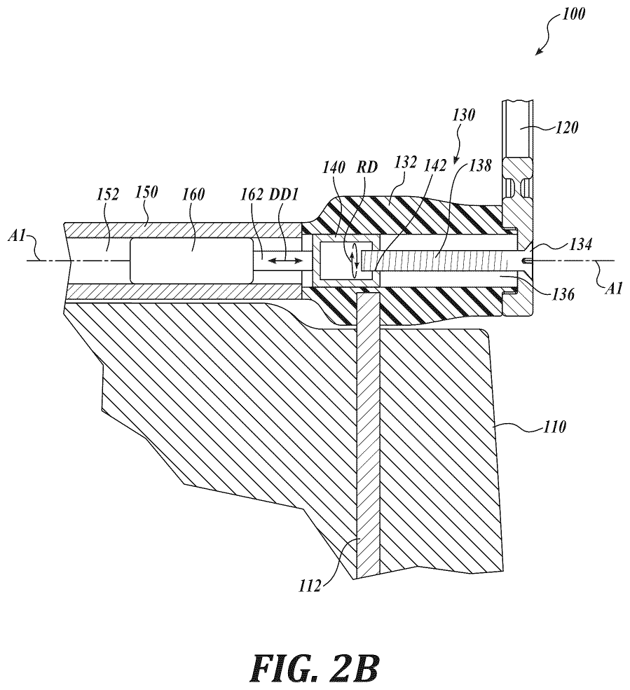

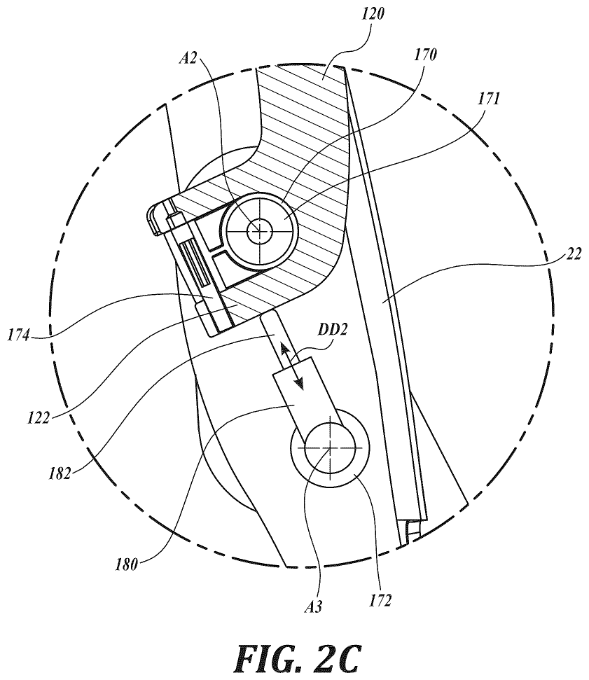

One or both of the seat backs 22a and 22b can include a soft-opening tray table assembly 100 (“assembly 100”) operably coupled to the seat base frame assembly 30 at a pivot tube 170. In the illustrated embodiments, the assembly 100 is configured to rotate at the pivot tube 170; however, other embodiments may have a fixed coupling at the interface between the assembly 100 and the seat base frame assembly 30. It should be appreciated that the certain seat assemblies 20a and 20b illustrated in FIGS. 1 and 2A should not be considered limiting on the present disclosure, and the tray table assemblies 100 can be coupled to various other types of seat assemblies and seat backs with fewer or additional features as desired. In addition, the particular location of the tray table assemblies 100 to the seat backs 22, the coupling of the tray table assemblies 100 to the seat base frame assembly 30 (e.g., at the pivot tube 170), and the latch 26 on the seat backs 22 illustrated in FIG. 1 should not be considered limiting on the present disclosure, as the components may be positioned at various locations relative to the seat backs 22 and/or at various locations relative to other components on the passenger seat assembly 10. Of course, one or more of these components can be omitted.

The tray table assemblies 100 can be latchable in a stowed position (e.g., as shown with respect to the seat back 22b with a latch 26b), and rotatable to a deployed position (e.g., as shown with respect to the seat back 22a with a latch 26a disengaged). When the latch 26a is disengaged, a tray table 110 of the tray table assembly 100 is permitted to rotate outwardly in a first rotation direction R1 about a first rotation axis A1 to a deployed position as shown with respect to the seat back 22a, and to a generally (e.g., approximately, etc.) horizontal position such that the passenger can rest items on the tray table 110 (food, drinks, electronics, books, etc.).

The following description generally references the tray table assembly 100 shown with respect to the seat back 22a; however, embodiments of the present disclosure are suitable for use with any seat configuration. The tray table 110 can rotate in the rotation direction R1 about a first hinge assembly 130 and a second hinge assembly 131, which will be described in greater detail below with respect to FIG. 2B. In some embodiments, the tray table assembly 100 can further rotate outwardly in a second rotation direction R2 about a second rotation axis A2 aligned with the pivot tube 170 to an extended position (e.g., closer to the body of the passenger), which will be described in greater detail below with respect to FIG. 2C.

FIG. 2A shows a cross-sectional side view of one embodiment of the assembly 100, with the tray table 110 in the deployed position relative to the seat back 22a. The tray table 110 can be operably coupled to the seat base frame assembly 30 by an extension arm 120 configured to rotatably carry the tray table 110 by interfacing with the first and second hinge assemblies 130 and 131 (See FIG. 1). As shown, the tray table 110 can rotate with respect to the extension arm 120 about the first rotational axis A1 by an angle θ1 between the tray table 110 and the seat back 22a. In some embodiments, the angle θ1 can be such that the tray table 110 is substantially horizontal in the deployed position, e.g., between about 70° and about 90°, or other suitable angles based on the configuration of the seat back 20a. In some embodiments, the assembly 100 can include a stop (e.g., features of the hinges 130 and 131, a feature of the extension arm 120, or other suitable features, not shown) configured to stop the rotation of the tray table 110 with respect to the extension arm 120 when the tray table 110 reaches a desirable deployed position.

As will be described below with reference to FIG. 2B, the rotation of the tray table 110 with respect to the extension arm 120 can include a counteracting rotational force from a frictional force, a potential energy storage, and/or viscous damping to limit the opening angular velocity of the tray table 110 during at least a portion of the deployment. In this regard, the hinges 130 and 131 can include components configured to impart the counteracting rotational force on the tray table 110 during deployment.

In some embodiments, a friction hinge can be positioned at either or both of the hinges 130 and 131 to transfer the kinetic energy of the tray table 110 caused by gravitational force during deployment into thermal energy by friction within the hinge. Examples of a suitable friction hinge include standard constant torque friction hinges manufactured by Reell Precision Manufacturing Corporation, located at 1259 Willow Lake Boulevard, St. Paul, Minnesota 55110, U.S.A. Other friction hinges are also suitable for use with the embodiments of the present disclosure.

In other embodiments, a spring hinge can be positioned at either or both of the hinges 130 and 131 to transfer the kinetic energy of the tray table 110 caused by gravitational force during deployment into potential energy within a spring within the hinge. Examples of a suitable spring hinge include the LAMP® HG-SH spring hinge manufactured by Sugatsune Kogyo Co., LTD., located at Jan. 8, 2011 Higashikanda, Chiyoda-ku, Tokyo, 101-8633, Japan. Other spring hinges are also suitable for use with the embodiments of the present disclosure.

In further embodiments, a damped hinge can be positioned at either or both of the hinges 130 and 131 to transfer the kinetic energy of the tray table 110 caused by gravitational force during deployment into thermal energy within a viscous fluid within the hinge. Examples of a suitable damped hinge include the LAMP® HG-JHM11 damper hinge manufactured by Sugatsune Kogyo Co., LTD., located at Jan. 8, 2011 Higashikanda, Chiyoda-ku, Tokyo, 101-8633, Japan. Other damped hinges are also suitable for use with the embodiments of the present disclosure.

In still further embodiments, a combination hinge (e.g., sprung and damped) can be positioned at either or both of the hinges 130 and 131 to transfer the kinetic energy of the tray table 110 caused by gravitational force during deployment into potential and thermal energy within a spring and viscous fluid within the hinge. Examples of a suitable damped hinge include the LAMP® HG-VH8 combination hinge manufactured by Sugatsune Kogyo Co., LTD., located at Jan. 8, 2011 Higashikanda, Chiyoda-ku, Tokyo, 101-8633, Japan. Other damped hinges are also suitable for use with the embodiments of the present disclosure.

In an example, the rotation of the tray table 110 from the stowed position to the deployed position can be counteracted by placing a spring hinge at the hinge 130 and a friction hinge at the hinge 131 or vice versa, a spring hinge at the hinge 130 and a damped hinge at the hinge 131 or vice versa, a friction hinge at the hinge 130 and a damped hinge at the hinge 131 or vice versa, a combination hinge at the hinges 130 and 131, or any other combination of the above hinges, including a standard hinge at either position 130 or 131 in combination with a spring, friction, damped, or combination hinge.

In some embodiments, the tray table 110 and the extension arm 120 can further rotate with respect to the seat base frame assembly 30 to an extended position by rotation of the extension arm 120 about the second rotational axis A2 by an angle θ2. The offset position of the second rotational axis A2 with respect to the first rotational axis A1 results in a translation of the tray table 110 to the extended position toward the passenger without substantially rotating the tray table 110 away from the general horizontal position after deployment of the tray table 110 with respect to the seat back 22a. In some embodiments, the angle θ2 can be such that the tray table 110 stays substantially horizontal in the extended position (e.g., between about 0° and about 10°, between about 0° and about 5°, etc.), or other suitable angles based on the configuration of the tray table assembly 100, the length of the extension arm 120, etc. In some embodiments, the assembly 100 can include a stop (e.g., features of the extension arm 120, features of the seat back 22a, or other suitable features, not shown) configured to stop the rotation of the extension arm 120 with respect to the seat back 22a when the tray table 110 reaches a desirable extended position.

As will be described with reference to FIG. 2C, the rotation of the tray table 110 and the extension arm 120 can include a counteracting rotational force from a frictional force, a potential energy storage, and/or viscous damping to limit the angular velocity of the tray table 110 during at least a portion of the rotation to the extended position. Although the illustrated embodiment of FIG. 2C includes a damping configuration, any of the hinge configurations described above with respect to the hinges 130 and 131 (e.g., friction hinge, spring hinge, damped hinge, and/or combination hinge, and any configuration thereof) are also suitable for use with the pivot tube 170.

Turning now to FIG. 2B, there is shown a cross-sectional top detail view of components of the tray table assembly 100 showing and embodiment of a hinge (e.g., the hinges 130 or 131) with damping in accordance with the present disclosure. Although FIG. 2B depicts the hinge 130 for purposes of discussion, the components are suitable for use in the position of the hinge 131 in a mirrored orientation with respect to a plane normal to the axis A1. The hinge 130 is rotatably coupled to the extension arm 120 and includes a hinge housing 132 having an annular cavity 136 axially aligned with the first rotation axis A1. The hinge 130 and the hinge 131 can be separated by a torque tube 150 extending therebetween to provide lateral stability to the tray table assembly 100 and provide a fixed distance between the extension arms 120 across the tray table assembly 100. The tray table 110 can further include a bracket 112 operably coupling the tray table 110 to the hinge 130 such that rotation of the tray table 110 correspondingly rotates the hinge 130 about the first rotation axis A1 with respect to the extension arm 120. The hinge 130 can further include an axial plunger 140 slidable within the annular cavity 136 of the hinge housing 132. In the illustrated embodiment, the axial plunger 140 is slidable along the first rotation axis A1 within the annular cavity 136, but is not rotatable with respect to the hinge housing 132. In this regard, the axial plunger 140 may have a feature (e.g., a protrusion, not shown) that is configured to interface with a feature (e.g., an axial slot, not shown) of the hinge housing 132.

The extension arm 120 can include a threaded member 134 (“fastener 134”) having a threaded portion 138 extending into the annular cavity 136. The threaded portion 138 can be inserted into the axial plunger 140 and configured to threadingly interface with a threaded interface portion 142 of the axial plunger. In some embodiments, rotation of the hinge 130 by the tray table 110 causes relative rotation of the axial plunger 140 in the direction of the arrow RD with respect to the fastener 134. Such relative rotation between the threaded portion 138 and the threaded interface portion 142 causes axial translation of the axial plunger 140 along the first rotation axis A1 within the annular cavity 136.

The rotation of the tray table 110 can be damped by positioning a linear damper assembly 160 within a cavity 152 of the torque tube 150 to interface with the axial plunger 140. In this regard, the linear damper assembly 160 can have a damping member 162 extending toward and abutting the axial plunger 140 during at least a portion of the axial translation of the axial plunger 140 as the tray table 110 is rotated from the stowed position to the deployed position. During deployment, the axial translation of the axial plunger 140 causes the damping member 162 to translate in the damping direction DD1 and damp the movement of the axial plunger 140, thereby damping the rotation of the tray table 110. In the illustrated embodiment, rotation of the tray table 110 in a counterclockwise direction in the orientation shown in FIG. 2A, causes an axial translation of the axial plunger 140 in the direction toward the linear damper assembly 160, counteracting the gravitational force on the tray table 110 as it is deployed.

Turning now to FIG. 2C, there is shown a cross-sectional side detail view of components of the tray table assembly 100 showing an embodiment of a pivot (e.g., a pivot at the pivot tube 170) with damping in accordance with the present disclosure. As shown, the extension arm 120 can be operably coupled to the pivot tube 170 by a clamping component 174. The pivot tube 170 can be configured to rotate with respect to a hinge tube 171 that is fixed with respect to the seat base frame assembly 30. In this regard, the extension arm 120 can rotate about the second rotation axis A2 during transition of the tray table assembly 100 to the extended position (e.g., by rotating the extension arm 120 by an angle of θ2 about the second rotation axis A2).

In a similar manner to the rotation of the tray table 110 about the first rotation axis A1, the rotation of the extension arm 120, and thereby the tray table assembly 100, can also be damped by positioning a linear damper assembly 180 to interface with the extension arm 120 during rotation to the extended position of the tray table assembly 100. The linear damper assembly 180 can be operably pinned at a pivot point 172 of the seat back 22. The linear damper assembly 180 can further include a damping member 182 that extends toward and abuts the extension arm 120 during at least a portion of the rotation of the extension arm 120 as the tray table assembly 100 is rotated to the extended position. During rotation to the extended position, a protrusion 122 of the extension arm 120 interfaces with the linear damper assembly 180 and causes the damping member 122 to translate in the damping direction DD2, damping the movement of the extension arm 120, thereby damping the rotation of the tray table assembly 100.

A collection of exemplary embodiments, including at least some explicitly enumerated as “ECs” (Example Combinations), providing additional description of a variety of embodiment types in accordance with the concepts described herein are provided below. These examples are not meant to be mutually exclusive, exhaustive, or restrictive; and the claimed subject matter is not limited to these example embodiments but rather encompasses all possible modifications and variations within the scope of the issued claims and their equivalents.

EC A. A soft-opening tray table assembly, comprising: a first arm configured to operably couple to a first portion of a passenger seat; a second arm configured to operably couple to a second portion of the passenger seat; and a tray table positioned between the first arm and the second arm, the tray table being pivotably coupled to the first arm by a first hinge and pivotably coupled to the second arm by a second hinge, wherein the first hinge counteracts a gravitational force acting on the tray table during rotation from a stowed position to a deployed position.

EC B. The soft-opening tray table assembly of claim 1, wherein the first hinge counteracts the gravitational force with at least one of a friction force, a spring force, and a viscous damping force.

EC C. The soft-opening tray table assembly of claim 1, wherein the second hinge counteracts the gravitational force acting on the tray table during rotation from the stowed position to the deployed position.

EC D. The soft-opening tray table assembly of claim 3, wherein the first hinge counteracts the gravitational force with a friction force, and wherein the second hinge counteracts the gravitational force with at least one of a friction force, a spring force, and a viscous damping force.

EC E. The soft-opening tray table assembly of claim 3, wherein the first hinge counteracts the gravitational force with a spring force, and wherein the second hinge counteracts the gravitational force with at least one of a friction force, a spring force, and a viscous damping force.

EC F. The soft-opening tray table assembly of claim 3, wherein the first hinge counteracts the gravitational force with a viscous damping force, and wherein the second hinge counteracts the gravitational force with at least one of a friction force, a spring force, and a viscous damping force.

EC G. The soft-opening tray table assembly of claim 1, wherein the first and second arms are pivotably coupled to the passenger seat, and wherein the first and second arms are configured to rotate the tray table from the stowed position to an extended position.

EC H. The soft-opening tray table assembly of claim 7, further comprising a linear damper assembly positioned between the aircraft passenger seat and the first arm, wherein the linear damper assembly is configured to dampen the movement of the tray table during rotation from the stowed position to the extended position.

EC I. The soft-opening tray table assembly of claim 8, wherein the linear damper assembly is a first linear damper assembly, and wherein the soft-opening tray table assembly further comprises a second linear damper assembly positioned between the aircraft passenger seat and the second arm, wherein the second linear damper assembly is configured to dampen the movement of the tray table during rotation from the stowed position to the extended position.

EC J. An aircraft passenger seat comprising the soft-opening tray table of claim 1.

EC K. A soft-opening tray table assembly for an aircraft passenger seat, the soft-opening tray table assembly comprising: a bracket configured to operably couple to the aircraft passenger seat; a tray table pivotably coupled to the bracket by a hinge, the hinge comprising: a hinge housing having an annular cavity axially aligned with a rotation axis of the tray table; an axial plunger slidable within the annular cavity; and a damper assembly positioned adjacent to the axial plunger; and a threaded member operably coupled to the bracket and extending within the annular cavity to interface with the axial plunger, wherein rotation of the axial plunger with respect to the threaded member during rotation of the tray table from a stowed position to a deployed position causes axial translation of the axial plunger within the annular cavity toward the damper assembly, and wherein the axial plunger abuts the damper assembly to viscously dampen at least a portion of the axial translation of the axial plunger.

EC L. The soft-opening tray table assembly of claim 11, wherein the bracket is a first bracket, the hinge is a first hinge, and the threaded member is a first threaded member, and wherein the tray table assembly further comprises: a second bracket configured to operably couple to the aircraft passenger seat away from the first bracket, wherein the tray table is pivotably coupled to the second bracket by a second hinge positioned on an opposite end of the tray table from the first hinge, and wherein the second hinge comprises: a second hinge housing having a second annular cavity axially aligned with the rotation axis of the tray table; a second axial plunger slidable within the second annular cavity; and a second damper assembly positioned adjacent to the second axial plunger; a second threaded member operably coupled to the second bracket and extending within the second annular cavity to interface with the second axial plunger, wherein rotation of the second axial plunger with respect to the second threaded member during rotation of the tray table from the stowed position to the deployed position causes axial translation of the second axial plunger within the second annular cavity toward the second damper assembly, and wherein the second axial plunger abuts the second damper assembly to viscously dampen at least a portion of the axial translation of the second axial plunger.

EC M. The soft-opening tray table assembly of claim 11, wherein the viscous damping of the axial translation of the axial plunger counteracts a gravitational force acting on the tray table during rotation from the stowed position to the deployed position.

EC N. The soft-opening tray table assembly of claim 12, wherein the viscous damping of the axial translation of the first and second axial plungers counteracts a gravitational force acting on the tray table during rotation from the stowed position to the deployed position.

ECO. The soft-opening tray table assembly of claim 11, wherein the bracket is pivotably coupled to the aircraft passenger seat, and wherein the bracket is configured to rotate the tray table from the stowed position to an extended position.

EC P. The soft-opening tray table assembly of claim 15, further comprising a linear damper assembly positioned between the aircraft passenger seat and the bracket, wherein the linear damper assembly is configured to dampen the movement of the tray table during rotation from the stowed position to the extended position.

EC Q. The soft-opening tray table assembly of claim 12, wherein the first and second brackets are pivotably coupled to the aircraft passenger seat, and wherein the first and second brackets are configured to rotate the tray table from the stowed position to an extended position.

EC R. The soft-opening tray table assembly of claim 17, further comprising a linear damper assembly positioned between the aircraft passenger seat and the first bracket, wherein the linear damper assembly is configured to dampen the movement of the tray table during rotation from the stowed position to the extended position.

EC S. The soft-opening tray table assembly of claim 18, wherein the linear damper assembly is a first linear damper assembly, and wherein the soft-opening tray table assembly further comprises a second linear damper assembly positioned between the aircraft passenger seat and the second bracket, wherein the second linear damper assembly is configured to dampen the movement of the tray table during rotation from the stowed position to the extended position.

In the foregoing description, specific details are set forth to provide a thorough understanding of exemplary embodiments of the present disclosure. It will be apparent to one skilled in the art, however, that the embodiments disclosed herein may be practiced without embodying all of the specific details. In some instances, well-known process steps have not been described in detail in order not to unnecessarily obscure various aspects of the present disclosure. Further, it will be appreciated that embodiments of the present disclosure may employ any combination of features described herein.

The present application may reference quantities and numbers. Unless specifically stated, such quantities and numbers are not to be considered restrictive, but exemplary of the possible quantities or numbers associated with the present application. Also in this regard, the present application may use the term “plurality” to reference a quantity or number. In this regard, the term “plurality” is meant to be any number that is more than one, for example, two, three, four, five, etc. The terms “about,” “approximately,” “near,” etc., mean plus or minus 10% of the stated value. For the purposes of the present disclosure, the phrase “at least one of A and B” is equivalent to “A and/or B” or vice versa, namely “A” alone, “B” alone or “A and B.”. Similarly, the phrase “at least one of A, B, and C,” for example, means (A), (B), (C), (A and B), (A and C), (B and C), or (A, B, and C), including all further possible permutations when greater than three elements are listed.

It should be noted that for purposes of this disclosure, terminology such as “upper,” “lower,” “vertical,” “horizontal,” “fore,” “aft,” “inner,” “outer,” “front,” “rear,” etc., should be construed as descriptive and not limiting the scope of the claimed subject matter. Further, the use of “including,” “comprising,” or “having” and variations thereof herein is meant to encompass the items listed thereafter and equivalents thereof as well as additional items. Unless limited otherwise, the terms “connected,” “coupled,” and “mounted” and variations thereof herein are used broadly and encompass direct and indirect connections, couplings, and mountings.

Throughout this specification, terms of art may be used. These terms are to take on their ordinary meaning in the art from which they come, unless specifically defined herein or the context of their use would clearly suggest otherwise.

The principles, representative embodiments, and modes of operation of the present disclosure have been described in the foregoing description. However, aspects of the present disclosure, which are intended to be protected, are not to be construed as limited to the particular embodiments disclosed. Further, the embodiments described herein are to be regarded as illustrative rather than restrictive. It will be appreciated that variations and changes may be made by others, and equivalents employed, without departing from the spirit of the present disclosure. Accordingly, it is expressly intended that all such variations, changes, and equivalents fall within the spirit and scope of the present disclosure as claimed.

1. A soft-opening tray table assembly, comprising:
a first arm configured to operably couple to a first portion of a passenger seat;
a second arm configured to operably couple to a second portion of the passenger seat; and
a tray table positioned between the first arm and the second arm, the tray table being pivotably coupled to the first arm by a first hinge and pivotably coupled to the second arm by a second hinge, wherein the first hinge counteracts a gravitational force acting on the tray table during rotation from a stowed position to a deployed position.

2. The soft-opening tray table assembly of claim 1, wherein the first hinge counteracts the gravitational force with at least one of a friction force, a spring force, and a viscous damping force.

3. The soft-opening tray table assembly of claim 1, wherein the second hinge counteracts the gravitational force acting on the tray table during rotation from the stowed position to the deployed position.

4. The soft-opening tray table assembly of claim 3, wherein the first hinge counteracts the gravitational force with a friction force, and wherein the second hinge counteracts the gravitational force with at least one of a friction force, a spring force, and a viscous damping force.

5. The soft-opening tray table assembly of claim 3, wherein the first hinge counteracts the gravitational force with a spring force, and wherein the second hinge counteracts the gravitational force with at least one of a friction force, a spring force, and a viscous damping force.

6. The soft-opening tray table assembly of claim 3, wherein the first hinge counteracts the gravitational force with a viscous damping force, and wherein the second hinge counteracts the gravitational force with at least one of a friction force, a spring force, and a viscous damping force.

7. The soft-opening tray table assembly of claim 1, wherein the first and second arms are pivotably coupled to the passenger seat, and wherein the first and second arms are configured to rotate the tray table from the stowed position to an extended position.

8. The soft-opening tray table assembly of claim 7, further comprising a linear damper assembly positioned between the aircraft passenger seat and the first arm, wherein the linear damper assembly is configured to dampen the movement of the tray table during rotation from the stowed position to the extended position.

9. The soft-opening tray table assembly of claim 8, wherein the linear damper assembly is a first linear damper assembly, and wherein the soft-opening tray table assembly further comprises a second linear damper assembly positioned between the aircraft passenger seat and the second arm, wherein the second linear damper assembly is configured to dampen the movement of the tray table during rotation from the stowed position to the extended position.

10. An aircraft passenger seat comprising the soft-opening tray table of claim 1.

11. A soft-opening tray table assembly for an aircraft passenger seat, the soft-opening tray table assembly comprising:
a bracket configured to operably couple to the aircraft passenger seat;
a tray table pivotably coupled to the bracket by a hinge, the hinge comprising:
a hinge housing having an annular cavity axially aligned with a rotation axis of the tray table;
an axial plunger slidable within the annular cavity; and
a damper assembly positioned adjacent to the axial plunger; and
a threaded member operably coupled to the bracket and extending within the annular cavity to interface with the axial plunger,
wherein rotation of the axial plunger with respect to the threaded member during rotation of the tray table from a stowed position to a deployed position causes axial translation of the axial plunger within the annular cavity toward the damper assembly, and
wherein the axial plunger abuts the damper assembly to viscously dampen at least a portion of the axial translation of the axial plunger.

12. The soft-opening tray table assembly of claim 11, wherein the bracket is a first bracket, the hinge is a first hinge, and the threaded member is a first threaded member, and wherein the tray table assembly further comprises:
a second bracket configured to operably couple to the aircraft passenger seat away from the first bracket, wherein the tray table is pivotably coupled to the second bracket by a second hinge positioned on an opposite end of the tray table from the first hinge, and wherein the second hinge comprises:
a second hinge housing having a second annular cavity axially aligned with the rotation axis of the tray table;
a second axial plunger slidable within the second annular cavity; and
a second damper assembly positioned adjacent to the second axial plunger;
a second threaded member operably coupled to the second bracket and extending within the second annular cavity to interface with the second axial plunger,
wherein rotation of the second axial plunger with respect to the second threaded member during rotation of the tray table from the stowed position to the deployed position causes axial translation of the second axial plunger within the second annular cavity toward the second damper assembly, and
wherein the second axial plunger abuts the second damper assembly to viscously dampen at least a portion of the axial translation of the second axial plunger.

13. The soft-opening tray table assembly of claim 11, wherein the viscous damping of the axial translation of the axial plunger counteracts a gravitational force acting on the tray table during rotation from the stowed position to the deployed position.

14. The soft-opening tray table assembly of claim 12, wherein the viscous damping of the axial translation of the first and second axial plungers counteracts a gravitational force acting on the tray table during rotation from the stowed position to the deployed position.

15. The soft-opening tray table assembly of claim 11, wherein the bracket is pivotably coupled to the aircraft passenger seat, and wherein the bracket is configured to rotate the tray table from the stowed position to an extended position.

16. The soft-opening tray table assembly of claim 15, further comprising a linear damper assembly positioned between the aircraft passenger seat and the bracket, wherein the linear damper assembly is configured to dampen the movement of the tray table during rotation from the stowed position to the extended position.

17. The soft-opening tray table assembly of claim 12, wherein the first and second brackets are pivotably coupled to the aircraft passenger seat, and wherein the first and second brackets are configured to rotate the tray table from the stowed position to an extended position.

18. The soft-opening tray table assembly of claim 17, further comprising a linear damper assembly positioned between the aircraft passenger seat and the first bracket, wherein the linear damper assembly is configured to dampen the movement of the tray table during rotation from the stowed position to the extended position.

19. The soft-opening tray table assembly of claim 18, wherein the linear damper assembly is a first linear damper assembly, and wherein the soft-opening tray table assembly further comprises a second linear damper assembly positioned between the aircraft passenger seat and the second bracket, wherein the second linear damper assembly is configured to dampen the movement of the tray table during rotation from the stowed position to the extended position.
